(19) United States
(12) Patent Application Publication
(10) Pub. No.: US 2012/0311080 A1
(43) Pub. Date: Dec. 6, 2012

(54) Management of Downloads from a Network-Based Digital Data Repository

(76) Inventors: Thomas Alsina, Mountain View, CA (US); Lucas Newman, San Francisco, CA (US); Jeffrey L. Robbin, Los Altos, CA (US); Scott Forstall, Mountain View, CA (US); Andrew Wadycki, Santa Clara, CA (US)

(21) Appl. No.: 13/488,290

(22) Filed: Jun. 4, 2012

Related U.S. Application Data
(60) Provisional application No. 61/525,180, filed on Aug. 18, 2011.
(60) Provisional application No. 61/525,177, filed on Aug. 18, 2011.
(60) Provisional application No. 61/493,321, filed on Jun. 3, 2011.

(51) Int. Cl. G06F 15/16; G06F 3/00

(52) U.S. Cl. 709/217; 715/738

(57) ABSTRACT

Improved techniques and systems for storage, delivery and acquisition of digital assets stored in cloud data storage. Cloud data storage can be provided by a cloud data repository that is capable of storing digital data for various users. A given user can access cloud data storage from any of his/her authorized client devices via a network. A given client device can access not only locally stored digital assets but also remotely stored digital assets from cloud data storage. In one embodiment, downloads of digital asserts resident in cloud data storage to client devices can be managed for improved efficiency and/or performance. For example, remotely stored digital assets that have been downloaded from cloud data storage can be cached in local storage. By caching certain digital assets, performance can be improved because the digital assets, although not formally stored locally, can be available locally from cache storage.

### CROSS-REFERENCE TO OTHER APPLICATIONS

This application claims priority to U.S. Provisional Patent Application No. 61/525,180, filed Aug. 18, 2011, entitled “MANAGEMENT OF DOWNLOADS FROM A NETWORK-BASED DIGITAL DATA REPOSITORY,” which is herein incorporated by reference.

This application also claims priority to U.S. Provisional Patent Application No. 61/525,177, filed Aug. 18, 2011, entitled “MANAGEMENT OF NETWORK-BASED DIGITAL DATA REPOSITORY,” which is herein incorporated by reference.

This application also claims priority to U.S. Provisional Patent Application No. 61/493,321, filed Jun. 3, 2011, entitled “MANAGEMENT OF NETWORK-BASED DIGITAL DATA REPOSITORY,” which is herein incorporated by reference.

### BACKGROUND OF THE INVENTION

Online stores and online shopping have become increasing more popular in recent years. Desktop and laptop computers have been used to purchase various goods and services from online stores. An online store may allow customers, via a network connection to the Internet, to browse, search and purchase various different items from the online store. Purchased items can be delivered by mail or make available for pickup at a store or another location.

Recently, digital assets (e.g., musical songs, movies, computer application programs) have become available for purchase from online stores. Moreover, digital assets have become available for delivery directly to the device used to purchase them. As such, today, a digital asset can be purchased from an online store by way of an electronic device (e.g., a desktop computer) from a residence and immediately delivered to the electronic device used to acquire the digital asset. In other words, after purchasing a digital asset from an online store via an electronic device, the digital asset can be “downloaded” by the electronic device for subsequent use thereon.

However, more recently, the number and variety of electronic devices with the ability to access online stores have dramatically increased. Today, a person may own and/or operate several electronic devices with the ability to access online stores, including a desktop computer, a laptop computer, a pad or tablet computer (e.g., iPad™), a smartphone, a media player, a gaming device, a television, and so on. In addition, an ever increasing number and types of digital assets are becoming available at online stores for various electronic devices, including, media, books, application programs, etc. As a result, management of delivery of digital assets to electronic devices can pose difficulties for users, especially those maintaining collections of various digital assets on several distinct electronic devices.

### SUMMARY

Improved techniques and systems for storage, delivery and acquisition of digital assets are disclosed. The techniques and systems are suitable and useful for storing, delivering and accessing digital assets (e.g., media assets) that have been acquired from online stores. The techniques and systems are also suitable and useful for storing, delivering and accessing digital assets that have been acquired from other than from online stores. Regardless, the digital assets become accessible from a network-based digital data repository (e.g., cloud data storage) via electronic devices (e.g., user devices) and thus usable by the electronic devices. The digital assets can include media assets and/or non-media assets.

One aspect of certain embodiments pertains to providing cloud data storage to participating client devices. Cloud data storage can be provided by a network-based repository that is capable of storing digital data for various users. As used herein, the network-based repository can be referred to as a remote data repository or a cloud data repository. The digital data being stored in the cloud data storage can be made available to respective users via a network, such as the Internet (or World Wide Web). Users can store in the cloud data storage various digital data, including digital assets that have been purchased online, digital assets acquired from other non-online means, and/or any other digital files of the user. Access to digital data via the cloud data storage can be restricted to authenticated users and to a limited number authorized devices (client device) per user. Hence, a given user can access the cloud data storage from any of his/her authorized client devices.

Another aspect of certain embodiments pertains to managing downloads of digital asserts resident in cloud data storage to client devices. A given client device can access not only locally stored digital assets but also remotely stored digital assets from the cloud data storage. In other words, remotely stored digital assets can be accessed by client devices, such as for downloading to local storage or for playing of the stored digital assets. A graphical user interface can be provided at the client devices to indicate availability of the locally stored digital assets as well as the remotely stored digital assets from the cloud data storage. In one embodiment, the graphical user interface can provide an integrated display in which both the locally stored digital assets as well as the remotely stored digital assets are depicted. In one implementation, the graphical user interface could include indicia to indicate whether the digital assets are resident locally or resident remotely in the cloud data storage. If a user were to request to play a remote asset, the data therefore would need to be downloaded (unless previously cached). By caching certain digital assets (e.g., that have been previously downloaded), device performance can be improved because the digital assets, although not formally stored locally, is available locally from cache storage. Also, by caching certain digital assets, power savings (as well as bandwidth consumption savings) can result because re-transmission of such data need not be performed (which is particular advantageous on client devices that couple to cloud data storage via a wireless link.

The invention can be implemented in numerous ways, including as a method, system, device, apparatus (including computer readable medium and graphical user interface). Several embodiments of the invention are discussed below.

As a method for accessing data to present a digital asset at an electronic device having a memory for data storage, one embodiment can, for example, include at least: receiving an indication of a digital asset that is to be played by the electronic device; determining whether the digital asset is unavailable locally from the local memory of the electronic device; determining whether the digital asset is available from a cloud data repository; downloading the digital asset from the cloud data repository to the electronic device if the digital asset is available from the cloud data repository but unavailable from the local memory of the electronic device; presenting the digital asset at the electronic device while the downloading occurs; and caching the digital asset at the electronic device while the downloading occurs.

As a method for accessing data to present a digital asset at an electronic device having a memory for data storage, another embodiment can, for example, include at least: receiving an indication of a digital asset that is to be played by the electronic device; determining whether the digital asset is available locally from the local memory of the electronic device; determining whether the digital asset is cached locally at the electronic device; determining whether the digital asset is available from a cloud data repository; downloading the digital asset from the cloud data repository to the electronic device if the digital asset is available from the cloud data repository but neither available from the local memory of the electronic device nor cached locally at the electronic device; and presenting the digital asset at the electronic device while the downloading occurs.

As a non-transitory computer readable medium including at least computer program code stored thereon for accessing data to present a digital asset at an electronic device having a memory for data storage, one embodiment can, for example, include at least: computer program code for receiving an indication of a digital asset that is to be played by the electronic device; computer program code for determining whether data for the digital asset is available locally from the local memory of the electronic device; computer program code for determining whether data for the digital asset is available from a cloud data repository; computer program code for downloading the data for the digital asset from the cloud data repository to the electronic device if the data for the digital asset is available from the cloud data repository but not available from the local memory of the electronic device; computer program code for presenting the data for the digital asset at the electronic device while the downloading occurs; and computer program code for caching the data for the digital asset at the electronic device while the downloading occurs.

As a non-transitory computer readable medium including at least computer program code stored thereon for accessing data to present a digital asset at an electronic device having a memory for data storage, one embodiment can, for example, include at least: computer program code for receiving an indication of a digital asset that is to be played by the electronic device; computer program code for determining whether data for the digital asset is available locally from the local memory of the electronic device; computer program code for determining whether data for the digital asset is cached locally at the electronic device; computer program code for determining whether data for the digital asset is available from a cloud data repository; computer program code for downloading the data for the digital asset from the cloud data repository to the electronic device when the data for the digital asset is available from the cloud data repository but neither available from the local memory of the electronic device nor cached locally at the electronic device; and computer program code for presenting the data for the digital asset at the electronic device while the downloading occurs.

As a method for presenting a digital asset on an electronic device, the electronic device having a local memory for data storage and having a network interface configured to couple to a network for accessing a cloud data repository, one embodiment can, for example, include at least: receiving an indication of a digital asset to be presented by the electronic device; accessing a database to determine whether a data file is resident locally or remotely, the data file containing data for the digital asset to be presented; obtaining a file locator for the data file from the database; thereafter retrieving the data file from the local memory using the file locator when the data file is resident locally; and retrieving the data file from a cloud data repository using the file locator when the data file is resident remotely.

As a non-transitory computer readable medium including at least computer program code stored thereon for presenting a digital asset on an electronic device, the electronic device having a local memory for data storage and having a network interface configured to couple to a network for accessing a cloud data repository, one embodiment can, for example, include at least: computer program code for receiving an indication of a digital asset to be presented by the electronic device; computer program code for accessing a database to determine whether a data file is resident locally or remotely, the data file containing data for the digital asset to be presented; computer program code for obtaining a file locator for the data file from the database; computer program code for retrieving the data file from the local memory using the file locator when the data file is resident locally; and computer program code for retrieving the data file from a cloud data repository using the file locator when the data file is resident remotely.

As a graphical user interface presented on a display device associated with an electronic device, one embodiment can, for example, include at least: a list of a plurality of digital assets, at least one of the digital assets is stored locally at the electronic device, and at least one of the digital assets is stored remotely at a cloud data repository; and at least one visual indicator to distinguish whether the digital assets are stored locally at the electronic device or remotely at the cloud data repository.

Various aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a network-based data management system according to one embodiment.

FIG. 2A is a state diagram of a hierarchical storage system for digital assets.

FIG. 2B is an exemplary graphical user interface according to one embodiment.

FIG. 3 is a flow diagram of a data retrieval and play process according to one embodiment.

FIG. 4A is a flow diagram of a cloud data retrieval process according to one embodiment.

FIG. 4B is a flow diagram of cache data retrieval process according to one embodiment.

FIG. 4C is a flow diagram of local data retrieval process according to one embodiment.

### DETAILED DESCRIPTION OF EMBODIMENTS OF THE INVENTION

Improved techniques and systems for storage, delivery and acquisition of digital assets are disclosed. The techniques and systems are suitable and useful for storing, delivering and accessing digital assets (e.g., media assets) that have been acquired from online stores. The techniques and systems are also suitable and useful for storing, delivering and accessing digital assets that have been acquired from other than from online stores. Regardless, the digital assets become accessible from a network-based digital data repository (e.g., cloud data storage) via electronic devices (e.g., user devices) and thus usable by the electronic devices. The digital assets can include media assets and/or non-media assets.

One aspect of certain embodiments pertains to providing cloud data storage to participating client devices. Cloud data storage can be provided by a network-based repository that is capable of storing digital data for various users. As used herein, the network-based repository can be referred to as a remote data repository or a cloud data repository. The digital data being stored in the cloud data storage can be made available to respective users via a network, such as the Internet (or World Wide Web). Users can store in the cloud data storage various digital data, including digital assets that have been purchased online, digital assets acquired from other non-online means, and/or any other digital files of the user. Access to digital data via the cloud data storage can be restricted to authenticated users and to a limited number authorized devices (client device) per user. Hence, a given user can access the cloud data storage from any of his/her authorized client devices.

Another aspect of certain embodiments pertains to managing downloads of digital asserts resident in cloud data storage to client devices. A given client device can access not only locally stored digital assets but also remotely stored digital assets from the cloud data storage. In other words, remotely stored digital assets can be accessed by client devices, such as for downloading to local storage or for playing of the stored digital assets. A graphical user interface can be provided at the client devices to indicate availability of the locally stored digital assets as well as the remotely stored digital assets from the cloud data storage. In one embodiment, the graphical user interface can provide an integrated display in which both the locally stored digital assets as well as the remotely stored digital assets are depicted. In one implementation, the graphical user interface could include indicia to indicate whether the digital assets are resident locally or resident remotely in the cloud data storage. If a user were to request to play a remote asset, the data therefore would need to be downloaded (unless previously cached). By caching certain digital assets (e.g., that have been previously downloaded), device performance can be improved because the digital assets, although not formally stored locally, is available locally from cache storage. Also, by caching certain digital assets, power savings (as well as bandwidth consumption savings) can result because re-transmission of such data need not be performed (which is particular advantageous on client devices that couple to cloud data storage via a wireless link.

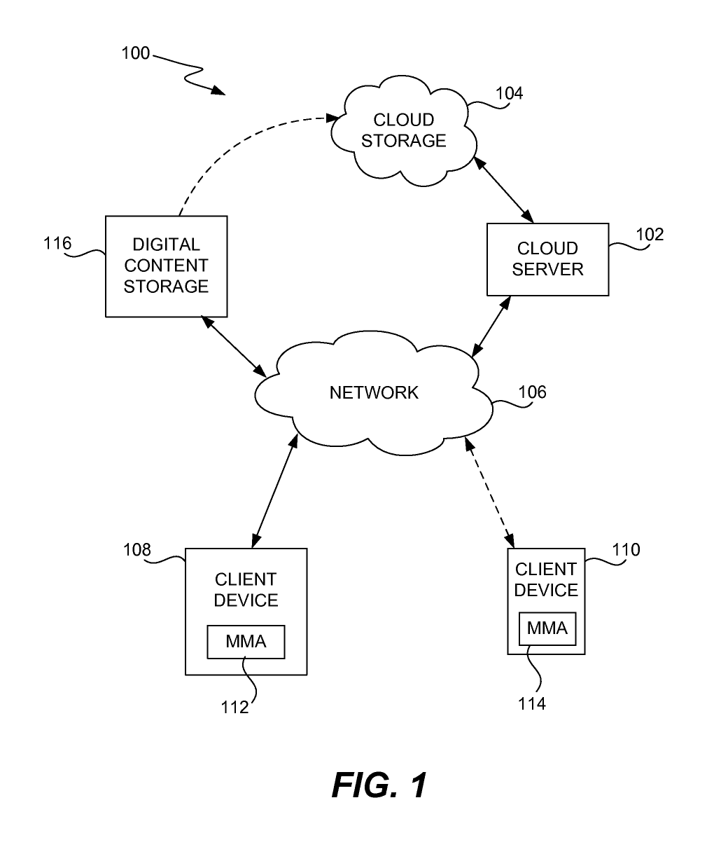

FIG. 1 is a block diagram of a network-based data management system 100 according to one embodiment. The network-based data management system 100 provides data management for a plurality of different users. The various users can operate one or more client devices to access digital data being stored remotely by the network-based data management system 100. The network-based data management system 100 can also manage synchronization of data between multiple client devices associated with a particular user. Still further, the network-based data management system 100 can manage download of digital data from remote storage to client devices.

The network-based data management system 100 includes a cloud server 102. The cloud server 102 is coupled to cloud storage 104. The cloud storage 104 provides a large amount of digital data storage that is coupled to a network 106. The cloud storage 106 can store digital data for a large number of different users. Although the cloud storage 104 is shared amongst a large number of different users, the digital data being stored for a given user can be accessible only by the given user. The cloud server 102 can serve to manage storage, access and distribution of data to and from the data storage by the cloud storage 104. The cloud storage 104 can also facilitate synchronization of data for users making use of the cloud storage 104.

The cloud storage 104 is accessible by way of the cloud server 102 by client devices associated with users. For example, as illustrated in FIG. 1, client device 108 and client device 110 can be coupled to the network 106 so as to gain access to data stored in the cloud storage 104. The client devices 108 and 110 can represent electronic devices, such as computing devices. For example, the client device 108 can represent a computer, while the client device 110 can represent a mobile phone (e.g., smart phone). Typically, the client devices 108 and 110 include an application program (or utility or operating system program) that facilitates access to the cloud server 102 by way of the network 106. The network 106 can consist of one or more wired or wireless networks. The client device 108 can, for example, connect to the network 106 by a wired connection, and the client device 110 can, for example, connect to the network 106 by a wireless connection.

Additionally, the client device 108 can include an application program, such as a media management application 112, that facilitates access, presentation and utilization of data stored either locally at the client device 108 or remotely at the cloud storage 104. Similarly, the client device 110 can include an application program, such as a media management application 114, that facilitates access, presentation and utilization of data stored either locally at the client device 110 or remotely at the cloud storage 104.

Still further, the network-based data management system 100 can include a digital content store 116. The digital content store 116 can facilitate electronic commerce to purchase, rent or otherwise acquire digital content. For example, the digital content store 116 can pertain to a digital media store (or online store) that offers digital content, such as movies, songs, audio books, applications, and/or games for purchase, rental or utilization. Additionally, if a user of the client device 108 or 110 were to purchase a digital media item from the digital content store 116, the digital media item could be downloaded to the corresponding client device 108 or 110 as well as also provided to the cloud storage 104. Hence, the cloud storage 104 can store the purchased digital media item (at least a link to the stored content) such that any of the user's client devices authorized for usage can access the cloud storage 104 associated with the user to gain access to the purchased digital media item. In this way, the purchase digital media item is directly added to the cloud storage 104 and thus does not need to be uploaded from the purchasing client device. Also, any of the user's other client devices that are authorized can also access (including downloading and playing) the purchased digital media item from the cloud storage 104.

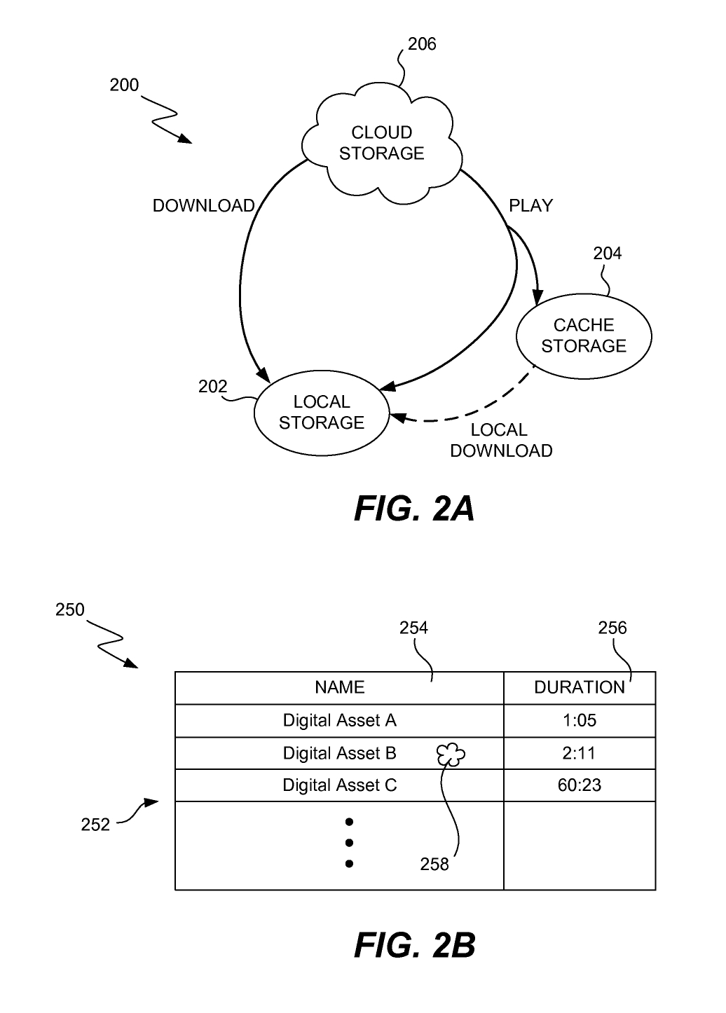

FIG. 2A is a state diagram of a hierarchical storage system 200 for digital assets. The hierarchical storage system 200 includes local storage 202, cache storage 204 and cloud storage 206. The local storage 202 is data storage provided on a client device, such as the client devices 108 and 110 illustrated in FIG. 1. The cache storage 204 is temporary data storage that is maintained in anticipation of future usage. Typically, the temporary data storage for the cache storage 204 is also provided on the client device. For example, a block of memory at the client device can be allocated as the cache storage 204 and managed to store data likely to be needed. The cloud storage 206 is provided remote from the client device but accessible through a computer network (e.g., the Internet). The cloud storage 206 can provide massive data storage for many distinct users, where each user can have its own isolated cloud storage.

To the extent that a digital asset is stored to the local storage 202, an application program operating on the client device can locally access and utilize the digital asset. For example, the digital assets could be read from the local storage 202 and played at the client device without any need for a network connection (wired or wireless).

However, if a user desires to access (e.g., play) a digital asset at the client device, but the particular digital access is stored in the cloud storage 206 but not the local storage 202 or the cache storage 204. In this case, the digital asset can be transmitted from the cloud storage 206 to the local storage 202 is temporarily stored, such as for the duration of an access session. In effect, the transmission is perceptively like a streaming of the digital asset but the mechanism used is a downloading of its data file. For example, the data file can be downloaded and temporarily stored at the local storage 202 while being accessed (e.g., played). Here, network communications are used to download the whole data file which can be more power efficient than streaming. Since the client device is typically a mobile, battery-powered device, battery power consumption is an important consideration. Additionally, as the data file is downloaded, it can also be placed in the cache storage 204. The data file can remain in the cache storage 204 until replaced by some other data asset deemed more likely used. For example, a First-In-First-Out (FIFO) caching policy, popularity policy, most recently played policy, or other policy can be used.

According to another scenario, if a user desired to access (e.g., play) a digital asset at the client device, but the particular digital access is stored in the cloud storage 206 and the cache storage 204, but not the local storage 202. In this case, the digital asset need not be transmitted from the cloud storage 206 to the local storage 202 because the associated data file is already resident in the cache storage 204. Instead, the location of the data file in a memory device at the client device is determined. Conceptually, this can be referred to a local download. The data file can then be located in the memory device at the client device and used to play the digital asset.

FIG. 2B is an exemplary graphical user interface 250 according to one embodiment. The graphical user interface 250 includes a table 252 that includes a name (or title) column 254 and an attribute column 256. As illustrated in FIG. 2B, the attribute in the attribute column 256 pertains to duration. However, various attributes of digital assets can be additionally or alternatively presented in a similar fashion. The name column 254, or an additional column, can visually distinguish whether the corresponding digital assets are stored locally at the client device or remotely at the cloud storage. In the embodiment shown in FIG. 2B, a remote indicator 258 can be displayed to indicate that the corresponding digital asset is stored remotely at the cloud storage. Hence, in the table 252 shown in FIG. 2B, there are three digital assets listed, namely Digital Asset A, Digital Asset B and Digital Asset C. Of these three digital assets listed, the Digital Assets A and C are stored locally at the client device and the Digital Asset B is stored remotely at the cloud storage. A user can typically interact with the graphical user interface 250 to perform user actions, such as play, download, or delete any of the digital media assets.

More generally, a graphical user interface (such as graphical user interface 250) can be presented on a display device associated with an electronic device. In one embodiment, the graphical user interface can include a list of a plurality of digital assets and at least one visual indicator. As noted above, the list can, for example, be implemented as a table (e.g., table 252), and the visual indicator can, for example, be implemented by the remote indicator 258. Typically, of the plurality of digital assets (which can be associated with a particular user via a user account) at least one of the digital assets is stored locally at the electronic device, and at least one of the digital assets is stored remotely at a cloud data repository. The least one visual indicator can serve to distinguish for a user of the electronic device whether the digital assets are stored locally at the electronic device or remotely at the cloud data repository. The appearance and/or placement of the visual indicator can vary with implementation. For example, as shown in FIG. 2B, Digital Asset A and Digital Asset C are stored locally at the electronic device, while Digital Asset B is stored remotely at the cloud data repository. In an exemplary delete operation, If a user were to interact with the electronic device to delete Digital Asset A from the electronic device, digital Asset A would effectively no longer be stored locally but would still reside in the cloud data repository and this would be illustrated in the graphical user interface 250 as having the remote indicator 258.

In one implementation, a given one of the digital assets presented in the graphical user interface can be stored in one of at least three ways. In a first way, the given one of the digital assets is stored locally on the electronic device. In a second way, the given one of the digital assets is stored remotely at the cloud data repository (and not stored in the electronic device). In a third way, the given one of the digital assets is cached locally on the electronic device but formally resides at the cloud data repository. The visual indicator can serves to visually indicate whether the given one of the digital assets is stored in the first way or the second way. In this embodiment, the visual indicator does not visually distinguish the second way and the third way. As such, the user of the electronic device, is not made aware that a digital asset is cached at the electronic device. However, in another implementation, the visual indicator(s) could visually distinguish the second way from the third way so as to inform the user that the user whether the digital asset is cached at the electronic device.

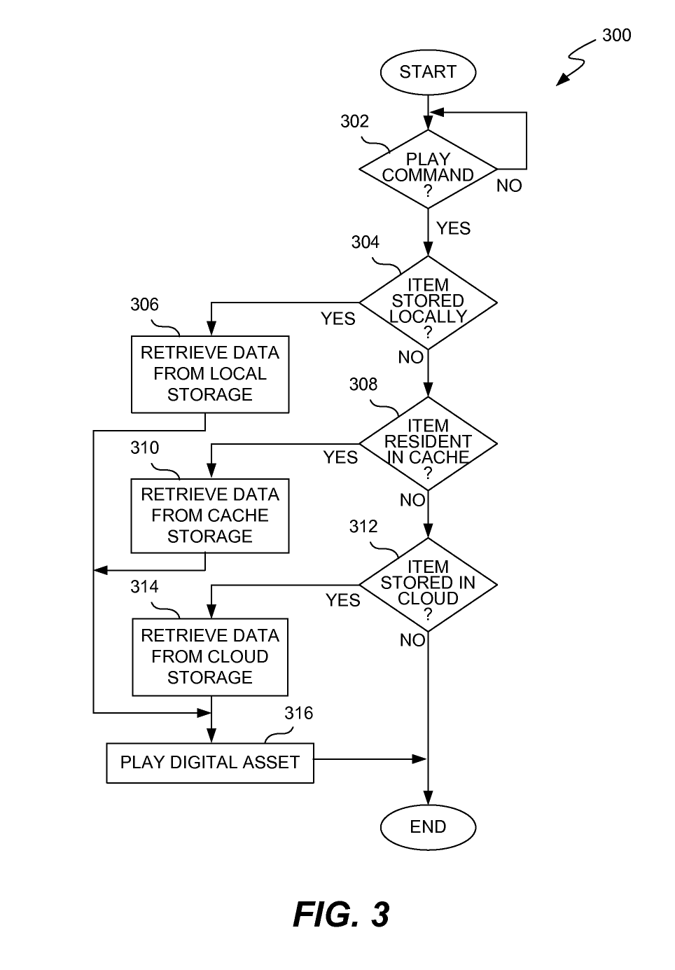

FIG. 3 is a flow diagram of a data retrieval and play process 300 according to one embodiment. The data retrieval and play process 300 can, for example, be performed by a data playback device, such as a computing device, multi-function consumer electronic device (e.g., smart phone), or other client device.

The data retrieval and play process 300 can include a decision 302 that determines whether a play command has been initiated. In one implementation, a play command can be received from a user requesting that a digital asset be played by the data playback device. For example, FIG. 2B illustrates a graphical user interface 250 from which a play command for a particular digital asset can be initiated.

When the decision 302 determines that a play command has not been received, the data retrieval and play process 300 can await the receipt of a play command. On the other hand, when the decision 302 determines that a play command has been received, the data retrieval and play process 300 can continue. The play command identifies a digital asset (or item) that the user is requesting to be played by the data playback device.

Upon receiving the play command, a decision 304 can determine whether the item to be played is stored locally at the data playback device. When the decision 304 determines that the item to be played is stored locally, data for the item can be retrieved 306 from the local storage. For example, the data playback device typically includes an electronic memory to support the local storage which serves to store electronic data, such as digital data (e.g., content data) and metadata for the item to be played.

Alternatively, when the decision 304 determines that the item to be played is not stored locally, a decision 308 can determine whether the item to be played is resident in cache storage. The cache storage is typically also provided on the data playback device and provides temporary data storage (cache memory) for data that is likely to be again accessed at the data playback device. When the decision 308 determines that the item to be played is resident in cache storage, data for this item can be retrieved 310 from the cache storage provided by the data playback device. In this case, although the data for the item to be played was not formally resident in the local storage of the data playback device, the data for the item to be played was available from the cache storage.

Still further, when the decision 308 determines that the item to be played is not resident in the cache storage, a decision 312 can determine whether the item to be played is stored in cloud storage. When the decision 302 determines that the data for the item to be played is available from the cloud storage, data for this item can be retrieved 314 from the cloud storage.

Accordingly, the data for the item to be played can be retrieved from any of local storage, cache storage and cloud storage. After the data for the item to be played has been retrieved 306, 310 or 314, the item, namely, the digital asset, can be played 316. After the item has been played 316, the data retrieval and play process can 300 can end. In the event that, for some reason, the data for the item to be played is not available from any of local storage, cache storage and cloud storage, the data retrieval and play process 300 does not initiate playing of the item because the associated data is not available, in which case the data retrieval and play process 300 can also end, though the requestor could be informed that the play command has been unsuccessful.

Hence, the data retrieval and play process 300 can provide a hierarchical storage of data, using local, cache and cloud storage. Data can be retrieved from its most appropriate source. Hence, the data for digital assets is readily available and downloading is used to retrieve the data when such data is unavailable from local storage or cache storage. Consequently, device performance is improved and less electrical power is consumed. For example, when the data playback device is wirelessly coupled to network but the data is available in the local storage or cache storage, a wireless network interface (e.g., wireless transceiver) need not be powered to download the data, which provides a power savings and/or a reduction in bandwidth consumption.

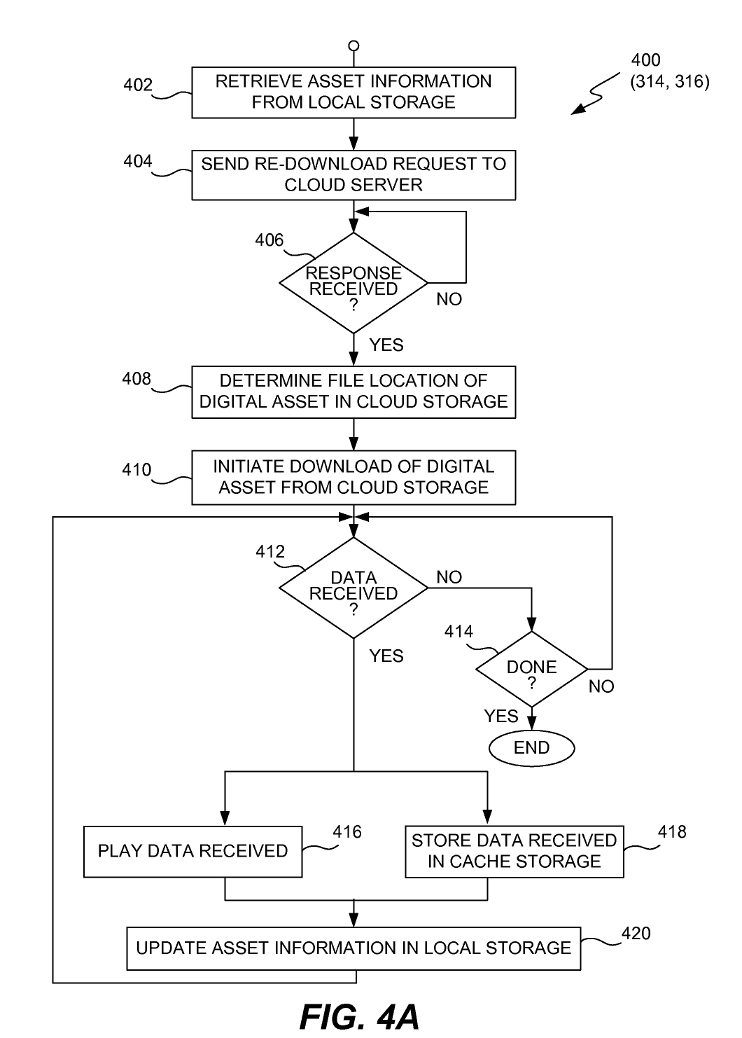

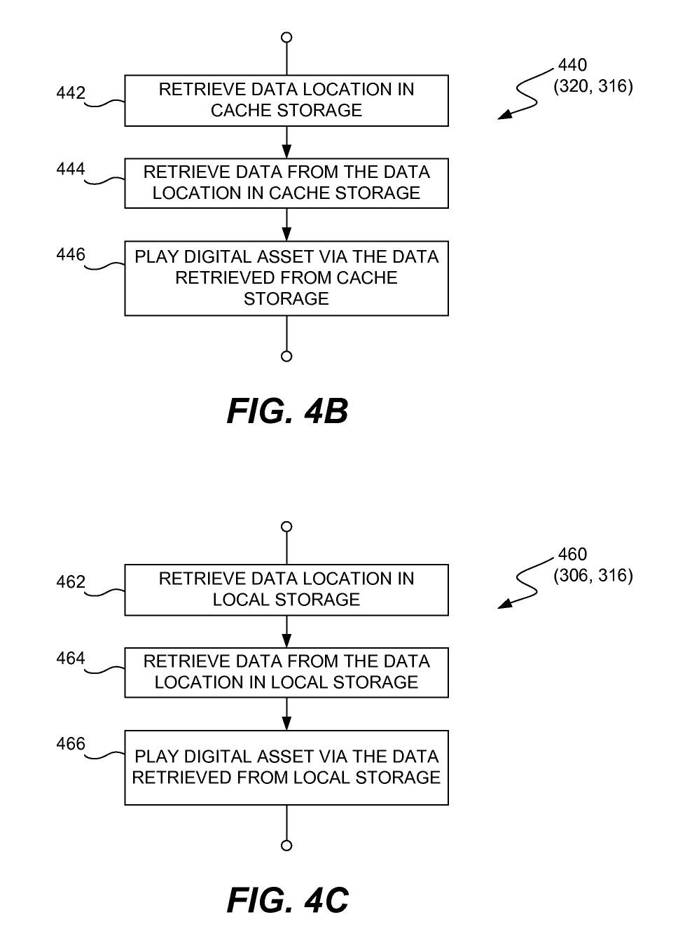

FIG. 4A is a flow diagram of a cloud data retrieval process 400 according to one embodiment. The cloud data retrieval process 400 can, for example, correspond to blocks 314 and 316 of FIG. 3, according to one embodiment. Here, the data for a digital asset (item) is to be retrieved from cloud storage.

The cloud data retrieval process 400 can retrieve 402 asset information for the item (digital asset) from the local storage. As noted above, the local storage can be data storage provided by the data playback device. For example, the local storage can be provided by semiconductor memory (e.g., FLASH memory) or a disc drive provided within the data playback device.

Next, a download request can be sent 404 to a cloud server. The cloud server serves to manage interaction with the cloud storage. After the download request has been sent 404 to the cloud server, a decision 406 can determine whether a response has been received. When the decision 406 determines that a response to the download request has not been received, the cloud data retrieval process 400 can await such a response.

Once the decision 406 determines that a response to the download request has been received, a file location of the digital asset in the cloud storage can be determined 408. Here, from the asset information provided in the response from the cloud server, the cloud data retrieval process 400 is able to determine 408 a file location for the digital asset in the cloud storage. In one embodiment, the asset information include location information, and the location information can include or be used to determine the file location for the digital asset in the cloud storage. Then, download of the digital asset from the cloud storage can be initiated 410. In one embodiment, the download of the digital asset from the cloud storage is initiated 410 by a request to retrieve the data file for the digital asset resident at the file location in the cloud storage. The download of the digital asset serves to copy the data file for the digital asset from the cloud storage to local storage.

Thereafter, a decision 412 can determine whether the data for the digital asset has been received. When the decision 412 determines that data for the digital asset has not been received, a decision 414 can determine whether the download of the digital asset is completed or should terminate (e.g., time out). When the decision 414 determines that the download of the digital asset is complete or should terminate, the cloud data retrieval process 400 can end. Alternatively, when the decision 414 determines that the download of the digital asset is not complete and should not terminate, the cloud data retrieval process 400 returns to repeat the decision 412 so as to continue to receive or await receipt of the data file for the digital asset.

Once the decision 412 determines that data (i.e., at least a portion of the data file) for the digital asset has been received from the cloud storage, the data received can be played 416 at the data playback device. Concurrently, the data received can also be stored 418 in the cache storage. The cache storage is typically limited in the amount of storage and a policy can be used to manage the data stored in the cache storage. For example, the cache storage can use a FIFO policy or other policy so that its cached data remains useful. Although the data could physically be stored in two distinct locations at the data playback device, typically, the data would be physically stored once at the data playback device but further managed by an associated database to track status information for the digital asset. For example, the status information can include location, amount, state and/or type of storage being provided.

Following the blocks 416 and 418, asset information in the local storage can be updated 420. In one embodiment, the associated database resident in the data playback device (or elsewhere) can be updated 422 reflect the status of the data for the digital asset with respect to the data playback device. This status information can, for example, include the location of the data, the amount of data, the particular data received, the state of the data, and/or type of storage being provided. After the asset information in the local storage has been updated 420, the cloud data retrieval process 400 can return to repeat the block 412 and subsequent blocks so that subsequent data for the digital asset being downloaded can be continually received even while other portions of such data are being played 416 and stored 418.

Here, the digital assets, even though being obtained from cloud storage, are able to be played rather quickly once an initial portion of the data is received. However, it should be noted that if the data received is encrypted, decryption would be needed prior to playing 416 the data. Also, if the data received is encrypted, the storage of the received data to the cache storage can be stored as received, can be decrypted and stored unencrypted, or decrypted and re-encrypted prior to storage.

The storage 418 of the data to the cache storage typically stores the entire data file for the associated digital asset. Advantageously, then if the same digital assets were to be played again (e.g., replayed or repeated), then if still resident in the cache, the data is thus available without requiring downloading. As a result, not only is the play performance improved because the data is locally available but also the electronic device need not consume electrical power to download the data file (which is particularly advantageous with battery-powered electronic devices). Additionally, when the data is available locally, network bandwidth is not consumed for download of the data.

In one embodiment, during download of a data file for a particular digital assets, a user might advance playback to a different portion of the digital asset (e.g., scrub operation). In such case, according to one embodiment, the downloading could also advance forward to obtain and play the data for the different portion. However, since the caching is concurrent with the downloading, the cached data can be incomplete (e.g., gaps in the cached data) in these types of situations. Hence, in one embodiment, a process (e.g., a utility or background process) can be used when network connectivity is available to download any missing portions of any of the digital assets resident in the cache storage.

FIG. 4B is a flow diagram of cache data retrieval process 440 according to one embodiment. The cache data retrieval process 440 can, for example, represent one embodiment for the usage of the blocks 310 and 316 of the data retrieval and play process 300 illustrated in FIG. 3.

The cache data retrieval process 440 can initially retrieve 442 a data location in the cache storage for the digital asset that is to be played. The data playback device can include not only cache memory by also a database that contains location information for digital assets known to the data storage device. The location information includes or can be used to determine the data location. Once the data location in the cache storage has been retrieved 442, data can be retrieved 444 from the data location in the cache storage. Thereafter, the digital asset can be played 446 via the data retrieved from the cache storage. In this case, the data for the data asset is available locally such that the no download or streaming of its data is needed, which results in not only more responsive playback of the digital asset but also improved power efficiency since data transmission (e.g., wireless communications) is not needed for acquisition of the data.

FIG. 4C is a flow diagram of local data retrieval process 460 according to one embodiment. The local data retrieval process 460 can, for example, represent one embodiment for the usage of the blocks 306 and 316 of the data retrieval and play process 300 illustrated in FIG. 3.

The local data retrieval process 460 can initially retrieve 462 a data location in the local storage for the digital asset that is to be played. The data playback device can include not only local memory by also the database that contains location information for digital assets known to the data storage device. The location information includes or can be used to determine the data location. Once the data location in the local storage for the digital asset to be played has been retrieved 462, data can be retrieved 464 from the data location in the local storage. Thereafter, the digital asset can be played 466 via the data retrieved from the local storage. In this case, the data for the data asset is available locally such that no download or streaming of its data is needed, which results in power efficiency since data transmission (e.g., wireless communications) is not needed for acquisition of the data.

In the processing discussed above regarding FIGS. 3, 4A, 4B and 4C, it should be understood that an item or a digital asset is typically processed on the order of one or more data portions (e.g., chunks). For example, the download and/or storage of a digital asset can yield a complete electronic data file or can just yield one or more data portions. The availability of data for an item or media asset can be evaluated on a file basis or on a portion basis. For example, if certain portions are available locally, then those portions can be retrieved locally without download, while other portions that are not available locally can be downloaded.

In view of the foregoing, it will readily be known that an electronic device provided in accordance with one or more embodiments can, for example, be a computing device (e.g., personal computer), mobile phone (e.g., cellular phone, smart phone), personal digital assistant (PDA), media player (e.g., music, videos, games, images), media storage device, camera, and/or the like. An electronic device may also be a multi-functional device that combines two or more of these device functionalities into a single device. A portable electronic device may support various types of network communications.

A portable electronic device can be provided as a hand-held electronic device. The term hand-held can generally refer to an electronic device with a form factor that is small enough to be comfortably held in one hand. A hand-held electronic device may be directed at one-handed operation or two-handed operation. In one-handed operation, a single hand is used to both support the device as well as to perform operations with the user interface during use. In two-handed operation, one hand is used to support the device while the other hand performs operations with a user interface during use or alternatively both hands support the device as well as perform operations during use. In some cases, the hand-held electronic device is sized for placement into a pocket of the user. By being pocket-sized, the user does not have to directly carry the device and therefore the device can be taken almost anywhere the user travels (e.g., the user is not limited by carrying a large, bulky and often heavy device).

Digital media assets (e.g., digital media items) can, for example pertain to video items (e.g., video files or movies), audio items (e.g., audio files or audio tracks, such as for songs, musical albums, podcasts or audiobooks), or image items (e.g., photos). The digital media assets can also include or be supplemented by text or multimedia files.

Additional information on digital asset delivery is provided in: (i) U.S. patent application Ser. No. 13/171,253, filed Jun. 28, 2011, entitled “INTELLIGENT DELIVERY AND ACQUISITION OF DIGITAL ASSETS,” which is herein incorporated by reference; and (ii) U.S. patent application Ser. No. 11/849,711, filed Sep. 4, 2007, and entitled “DIGITAL ASSET DELIVERY TO DIFFERENT DEVICES,” which is hereby incorporated herein by reference, and its corresponding US Patent Publication 2009/0063301 A1 is also hereby incorporated herein by reference.

The various aspects, features, embodiments or implementations of the invention described above can be used alone or in various combinations.

The invention is preferably implemented by software, hardware, or a combination of hardware and software. The invention can also be embodied as computer readable code on a computer readable medium. The computer readable medium is any data storage device that can store data which can thereafter be read by a computer system. Examples of the computer readable medium generally include read-only memory and random-access memory. More specific examples of computer readable medium are tangible and include Flash memory, EEPROM memory, memory card, CD-ROM, DVD, hard drive, magnetic tape, and optical data storage device. The computer readable medium can also be distributed over network-coupled computer systems so that the computer readable code is stored and executed in a distributed fashion.

The advantages of various embodiments of the invention are numerous. Different aspects, embodiments or implementations may, but need not, yield one or more of the following advantages. One advantage of at least some embodiments is that digital assets can be access from a common interface and provided to users in an efficient manner. Another advantage of at least some embodiments is that if digital assets are located remotely, when needed, they are download and not streamed for more efficient operation, including improved power efficiency. Still another advantage of at least some embodiments is that those remotely located assets that have been downloaded for playback can be cached for potential subsequent use.

The many features and advantages of the present invention are apparent from the written description. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for accessing data to present a digital asset at an electronic device having a memory for data storage, the method comprising:
receiving an indication of a digital asset that is to be played by the electronic device;
determining whether the digital asset is unavailable locally from the local memory of the electronic device;
determining whether the digital asset is available from a cloud data repository;
downloading the digital asset from the cloud data repository to the electronic device if the digital asset is available from the cloud data repository but unavailable from the local memory of the electronic device;
presenting the digital asset at the electronic device while the downloading occurs; and
caching the digital asset at the electronic device while the downloading occurs.

2. A method as recited in claim 1, wherein the electronic device includes an asset database that includes asset information pertaining to a plurality of digital assets that are available to the electronic device.

3. A method as recited in claim 2, wherein the asset information includes location information, the location information indicating where the corresponding digital assets is stored.

4. A method as recited in claim 3, wherein the determining of whether the digital asset is available from a cloud data repository comprises:
accessing the location information corresponding to the digital asset from the asset database; and
determining of whether the digital asset is available from a cloud data repository based on the location information.

5. A method as recited in claim 1, wherein the method further comprises:
subsequently receiving another indication that the digital asset is to be played by the electronic device;
determining, in response to the another indication, whether the digital asset is cached locally at the electronic device;
accessing data of the digital asset that has been cached at the electronic device when the determining determines that the digital asset is cached locally at the electronic device; and
presenting the accessed data of the digital asset at the electronic device.

6. A method as recited in claim 5, wherein the method further comprises:
determining, in response to the another indication, whether the digital asset is available from the cloud data repository;
downloading the digital asset from the cloud data repository to the electronic device if the digital asset is available from the cloud data repository but not available from either the local memory of the electronic device or from being cached locally.

7. A method for accessing data to present a digital asset at an electronic device having a memory for data storage, the method comprising:
receiving an indication of a digital asset that is to be played by the electronic device;
determining whether the digital asset is available locally from the local memory of the electronic device;
determining whether the digital asset is cached locally at the electronic device;
determining whether the digital asset is available from a cloud data repository;
downloading the digital asset from the cloud data repository to the electronic device if the digital asset is available from the cloud data repository but neither available from the local memory of the electronic device nor cached locally at the electronic device; and
presenting the digital asset at the electronic device while the downloading occurs.

8. A method as recited in claim 7, wherein the method further comprises:
caching the digital asset at the electronic device while the downloading occurs.

9. A method as recited in claim 8, wherein the method further comprises:
subsequently receiving another indication that the digital asset is to be played by the electronic device;
determining, in response to the another indication, whether the digital asset is cached locally at the electronic device;
accessing data of the digital asset that has been cached at the electronic device when the determining determines that the digital asset is cached locally at the electronic device; and
presenting the accessed data of the digital asset at the electronic device.

10. A non-transitory computer readable medium including at least computer program code stored thereon for accessing data to present a digital asset at an electronic device having a memory for data storage, the computer readable medium comprising:
computer program code for receiving an indication of a digital asset that is to be played by the electronic device;
computer program code for determining whether data for the digital asset is available locally from the local memory of the electronic device;
computer program code for determining whether data for the digital asset is available from a cloud data repository;
computer program code for downloading the data for the digital asset from the cloud data repository to the electronic device if the data for the digital asset is available from the cloud data repository but not available from the local memory of the electronic device;
computer program code for presenting the data for the digital asset at the electronic device while the downloading occurs; and
computer program code for caching the data for the digital asset at the electronic device while the downloading occurs.

11. A non-transitory computer readable medium including at least computer program code stored thereon for accessing data to present a digital asset at an electronic device having a memory for data storage, the computer readable medium comprising:
computer program code for receiving an indication of a digital asset that is to be played by the electronic device;
computer program code for determining whether data for the digital asset is available locally from the local memory of the electronic device;
computer program code for determining whether data for the digital asset is cached locally at the electronic device;
computer program code for determining whether data for the digital asset is available from a cloud data repository;
computer program code for downloading the data for the digital asset from the cloud data repository to the electronic device when the data for the digital asset is available from the cloud data repository but neither available from the local memory of the electronic device nor cached locally at the electronic device; and
computer program code for presenting the data for the digital asset at the electronic device while the downloading occurs.

12. A method for presenting a digital asset on an electronic device, the electronic device having a local memory for data storage and having a network interface configured to couple to a network for accessing a cloud data repository, the method comprising:
receiving an indication of a digital asset to be presented by the electronic device;
accessing a database to determine whether a data file is resident locally or remotely, the data file containing data for the digital asset to be presented;
obtaining a file locator for the data file from the database;
thereafter retrieving the data file from the local memory using the file locator when the data file is resident locally; and
retrieving the data file from a cloud data repository using the file locator when the data file is resident remotely.

13. A method as recited in claim 12, wherein the method further comprises:
caching the data file from the cloud data repository in the data storage of the electronic device while the data is being retrieved from the cloud data repository.

14. A method as recited in claim 13, wherein the method further comprises:
updating, following or during the caching, the file locator to reference the data file cached at the data storage of the electronic device.

15. A method as recited in claim 12, wherein the file locator is a URL.

16. A non-transitory computer readable medium including at least computer program code stored thereon for presenting a digital asset on an electronic device, the electronic device having a local memory for data storage and having a network interface configured to couple to a network for accessing a cloud data repository, the computer readable medium comprising:
computer program code for receiving an indication of a digital asset to be presented by the electronic device;
computer program code for accessing a database to determine whether a data file is resident locally or remotely, the data file containing data for the digital asset to be presented;
computer program code for obtaining a file locator for the data file from the database;
computer program code for retrieving the data file from the local memory using the file locator when the data file is resident locally; and
computer program code for retrieving the data file from a cloud data repository using the file locator when the data file is resident remotely.

17. A graphical user interface presented on a display device associated with an electronic device, comprising:
a list of a plurality of digital assets, at least one of the digital assets is stored locally at the electronic device, and at least one of the digital assets is stored remotely at a cloud data repository; and
at least one visual indicator to distinguish whether the digital assets are stored locally at the electronic device or remotely at the cloud data repository.

18. A graphical user interface as recited in claim 17, wherein a given one of the digital assets are stored in one of at least two manners,
when the given one of the digital assets is stored in a first way, the given one of the digital assets is stored locally on the electronic device, and
when the given one of the digital assets is stored in a second way, the given one of the digital assets is stored remotely at the cloud data repository.

19. A graphical user interface as recited in claim 18, wherein the at least one visual indicator serves to visually indicate whether the given one of the digital assets is stored in the first way or the second way.

20. A graphical user interface as recited in claim 17, wherein a given one of the digital assets are stored in one of at least three manners,
when the given one of the digital assets is stored in a first way, the given one of the digital assets is stored locally on the electronic device,
when the given one of the digital assets is stored in a second way, the given one of the digital assets is stored remotely at the cloud data repository, and
when the given one of the digital assets is stored in a third way, the given one of the digital assets is cached locally at the cloud data repository.

21. A graphical user interface as recited in claim 20, wherein the at least one visual indicator serves to visually indicate whether the given one of the digital assets is stored in the first way or the second way, and wherein the visual indicator does not visually distinguish the second way and the third way.
